(19) United States
(12) Patent Application Publication
(10) Pub. No.: US 2024/0414682 A1
(43) Pub. Date: Dec. 12, 2024

(54) SELECTION AND REPORTING OF REFERENCE PRS RESOURCES IN BATCH REPORTING MODE

(71) Applicant: QUALCOMM Incorporated, San Diego, CA (US)

(72) Inventors: Mukesh KUMAR, Hyderabad, Punjab (IN); Guttorm Ringstad OPSHAUG, Redwood City, CA (US); Alexandros MANOLAKOS, Athens, Attikí (GR)

(21) Appl. No.: 18/715,664

(22) PCT Filed: Feb. 1, 2023
(86) PCT No.: PCT/US2023/061775

§ 371 Date: May 31, 2024

(30) Foreign Application Priority Data
Feb. 11, 2022 (GR) 20220100131

(51) Int. Cl. H04W 64/00; H04B 17/309; H04L 5/00; H04W 72/563

(52) U.S. Cl. CPC H04W 64/00; H04B 17/346; H04L 5/0051; H04W 72/563

(57) ABSTRACT

Techniques for selecting a reference signal for positioning of a user equipment (UE) may comprise receiving a positioning reference signal (PRS) configuration that indicates a duration of time during which, for each of a plurality of PRS instances, the UE is to perform at least one respective measurement using at least one reference PRS resource. An indication that the UE is to provide a batch report indicative of the measurements also may be received. Performing the at least one respective measurement for each instance of the plurality of PRS instances may comprise selecting, from a plurality of candidate PRS resources, the at least one reference PRS resource based at least in part on a measured characteristic of the at least one reference PRS resource, or a received indication of the at least one reference PRS resource, or a combination thereof.

### BACKGROUND

### 1. Field of Disclosure

The present disclosure relates generally to the field of wireless communications, and more specifically to determining the location of a User Equipment (UE) using radio frequency (RF) signals.

### 2. Description of Related Art

In a data communication network, various positioning techniques can be used to determine the position of a mobile device (referred to herein as a UE). Some of these positioning techniques may involve the UE taking the measurements of RF signals sent from wireless nodes (e.g., base stations) of the communication network over a period of time. These measurements may be reported by the UE to a network entity (e.g., a location server) in batches. For measurements using reference RF signals, there are limitations to reporting which reference RF signals are used when batch reporting is performed.

### BRIEF SUMMARY

Embodiments provided herein address these and other issues by enabling the UE to select a best reference positioning reference signal (PRS) resource to use in a batch reporting mode and/or select multiple reference PRS resources to use during a measurement window for batch reporting. Embodiments further enable reporting of such selection (including the use of multiple reference PRS resources) to a location server.

An example method of selecting a reference signal for positioning of a user equipment (UE), according to this disclosure, may comprise receiving, at the UE, a positioning reference signal (PRS) configuration for a positioning session of the UE, wherein the PRS configuration indicates a duration of time during which, for each instance of a plurality of PRS instances, the UE is to perform at least one respective measurement using at least one reference PRS resource. The method also may comprise receiving, at the UE, an indication that the UE is to provide a batch report indicative of the at least one respective measurement for each instance of the plurality of PRS instances. The method also may comprise performing the at least one respective measurement for each instance of the plurality of PRS instances, wherein performing the at least one respective measurement for each instance of the plurality of PRS instances comprises selecting, from a plurality of candidate PRS resources, the at least one reference PRS resource based at least in part on: a measured characteristic of the at least one reference PRS resource, or a received indication of the at least one reference PRS resource, or a combination thereof.

An example method of supporting batch reporting of reference signals for positioning of a user equipment (UE), according to this disclosure, may comprise sending, from a location server to the UE, a positioning reference signal (PRS) configuration for a positioning session of the UE, wherein the PRS configuration indicates a duration of time spanning a plurality of PRS instances during which the UE is to perform a plurality of measurements. The method also may comprise sending, to the UE, an indication that the UE is to provide a batch report indicative of the plurality of measurements. The method also may comprise receiving the batch report, wherein the batch report indicates a plurality of reference PRS resources used by the UE to perform the plurality of measurements. The method also may comprise, responsive to receiving the batch report, determining a location of the UE based at least in part on the plurality of measurements.

An example user equipment (UE) for selecting a reference signal for positioning of the UE, according to this disclosure, may comprise a transceiver, a memory, one or more processors communicatively coupled with the transceiver and the memory, wherein the one or more processors are configured to receive, via the transceiver, a positioning reference signal (PRS) configuration for a positioning session of the UE, wherein the PRS configuration indicates a duration of time during which, for each instance of a plurality of PRS instances, the UE is to perform at least one respective measurement using at least one reference PRS resource. The one or more processors further may be configured to receive, via the transceiver, an indication that the UE is to provide a batch report indicative of the at least one respective measurement for each instance of the plurality of PRS instances. The one or more processors further may be configured to perform the at least one respective measurement for each instance of the plurality of PRS instances, wherein performing the at least one respective measurement for each instance of the plurality of PRS instances comprises selecting, from a plurality of candidate PRS resources, the at least one reference PRS resource based at least in part on: a measured characteristic of the at least one reference PRS resource, or a received indication of the at least one reference PRS resource, or a combination thereof.

An example location server for supporting batch reporting of reference signals for positioning of a user equipment (UE), according to this disclosure, may comprise a transceiver, a memory, one or more processors communicatively coupled with the transceiver and the memory, wherein the one or more processors are configured to send, via the transceiver to the UE, a positioning reference signal (PRS) configuration for a positioning session of the UE, wherein the PRS configuration indicates a duration of time spanning a plurality of PRS instances during which the UE is to perform a plurality of measurements. The one or more processors further may be configured to send, via the transceiver to the UE, an indication that the UE is to provide a batch report indicative of the plurality of measurements. The one or more processors further may be configured to receive the batch report via the transceiver, wherein the batch report indicates a plurality of reference PRS resources used by the UE to perform the plurality of measurements. The one or more processors further may be configured to responsive to receiving the batch report, determine a location of the UE based at least in part on the plurality of measurements.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIG. 3 is a diagram showing an example of how beamforming may be performed, according to some embodiments.

FIG. 4 is a diagram showing an example of a frame structure for NR and associated terminology.

FIG. 5 is a diagram showing an example of a radio frame sequence with Positioning Reference Signal (PRS) positioning occasions.

FIG. 6 is a diagram showing example combination (comb) structures, illustrating how RF signals may utilize different sets of resource elements, according to some embodiments.

FIG. 7 is a diagram of a hierarchical structure of how PRS resources and PRS resource sets may be used by different Transmission Reception Point (TRPs) of a given position frequency layer (PFL), as defined in 5G NR.

FIG. 8 is a time diagram illustrating two different options for slot usage of a resource set, according to an embodiment.

FIG. 9 is a graph illustrating an example of a batch reporting timeline for a user equipment (UE), according to an embodiment.

FIG. 10 is a flow diagram of selecting a reference signal for positioning of a UE, according to an embodiment.

FIG. 11 is a flow diagram of supporting batch reporting of reference signals for positioning of a UE, according to an embodiment.

FIG. 12 is a block diagram of an embodiment of a UE, which can be utilized in embodiments as described herein.

FIG. 13 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

As noted, to position a UE in a wireless communication network, a location server of the wireless communication network may engage in a positioning session with the UE and coordinate RF signals to be transmitted by the UE and/or neighboring wireless nodes, such as base stations. The UE may perform measurements of RF signals it receives and may then report the measurements to the location server. In some instances, such as in response to a request from the location server, the UE may report measurements in batches. However, for measurements using reference RF signals, there are limitations to reporting which reference RF signals are used when batch reporting is performed. In cellular networks using 5G, governing standards for measurement reporting (established by 3GPP), for example, only a single reference RF signal may be reported. This imposes limitations on the UE for performing the measurements taken over a measurement window for which the batch report applies. In cases where the UE is moving, for example, the best reference RF signal at the beginning of the measurement window may not be the best reference RF signal at the end of the measurement window.

Embodiments provided herein address these and other issues by enabling the UE to select a best reference positioning reference signal (PRS) resource to use in a batch reporting mode and/or select multiple reference PRS resources to use during a measurement window for batch reporting. Embodiments further enable reporting of such selection (including the use of multiple reference PRS resources) to a location server. Additional details will be provided after a description of relevant technology.

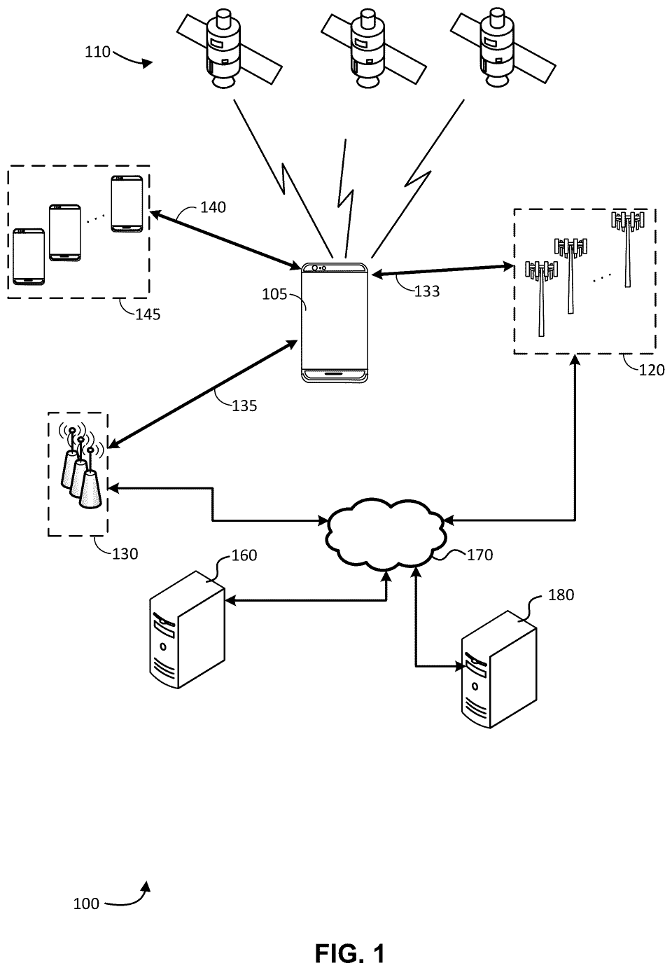

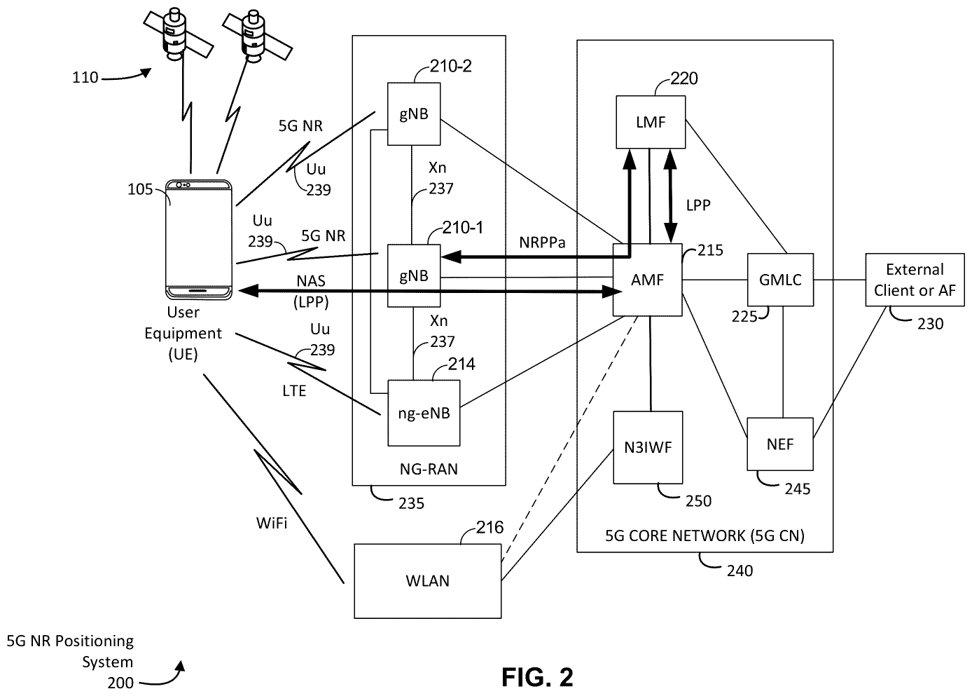

FIG. 1 is a simplified illustration of a positioning system 100 in which a UE 105, location server 160, and/or other components of the positioning system 100 can use the techniques provided herein for selecting and reporting reference PRS resources, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other UEs 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When one or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of another UE 145 at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

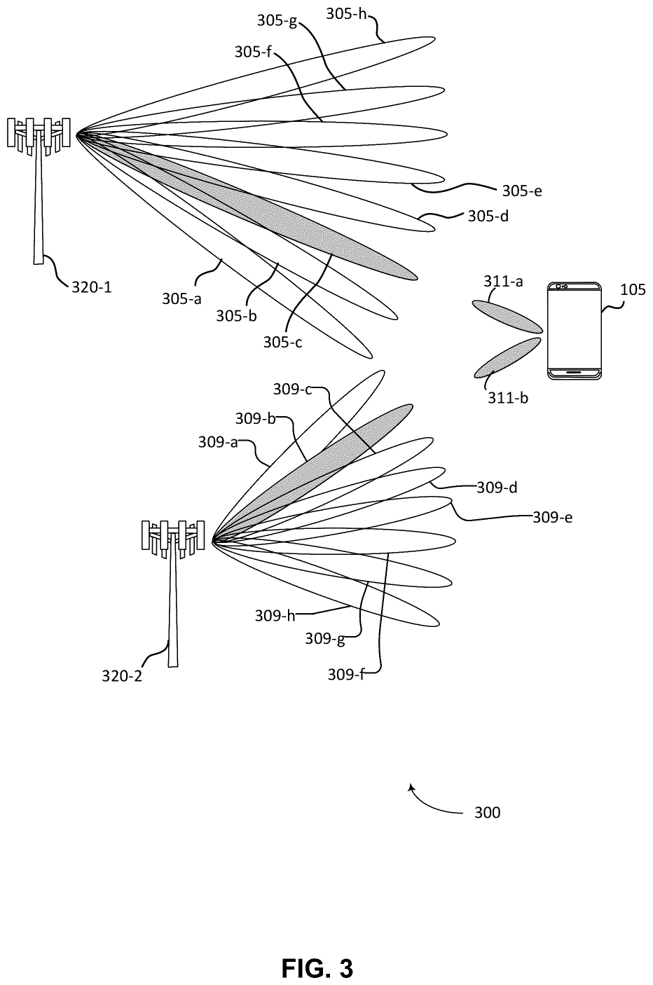

FIG. 3 is a diagram illustrating a simplified environment 300 including two Base stations 320-1 and 320-2 (which may correspond to base stations 120 of FIG. 1 and/or gNBs 210 and/or ng-eNB 214 of FIG. 2) with antenna arrays that can perform beamforming to produce directional beams for transmitting and/or receiving RF signals. FIG. 3 also illustrates a UE 105, which may also use beamforming for transmitting and/or receiving RF signals. Such directional beams are used in 5G NR wireless communication networks. Each directional beam may have a beam width centered in a different direction, enabling different beams of a BASE STATION 320 to correspond with different areas within a coverage area for the BASE STATION 320.

Different modes of operation may enable Base stations 320-1 and 320-2 to use a larger or smaller number of beams. For example, in a first mode of operation, a BASE STATION 320 may use 16 beams, in which case each beam may have a relatively wide beam width. In a second mode of operation, a BASE STATION 320 may use 64 beams, in which case each beam may have a relatively narrow beam width. Depending on the capabilities of a BASE STATION 320, the TRP may use any number of beams the BASE STATION 320 may be capable of forming. The modes of operation and/or number of beams may be defined in relevant wireless standards and may correspond to different directions in either or both azimuth and elevation (e.g., horizontal and vertical directions). Different modes of operation may be used to transmit and/or receive different signal types. Additionally or alternatively, the UE 105 may be capable of using different numbers of beams, which may also correspond to different modes of operation, signal types, etc.

In some situations, a BASE STATION 320 may use beam sweeping. Beam sweeping is a process in which the BASE STATION 320 may send an RF signal in different directions using different respective beams, often in succession, effectively “sweeping” across a coverage area. For example, a BASE STATION 320 may sweep across 120 or 360 degrees in an azimuth direction, for each beam sweep, which may be periodically repeated. Each direction beam can include an RF reference signal (e.g., a PRS resource), where base station 320-1 produces a set of RF reference signals that includes Tx beams 305-a, 305-b, 305-c, 305-d, 305-e, 305-f, 305-g, and 305-h, and the base station 320-2 produces a set of RF reference signals that includes Tx beams 309-a, 309-b, 309-c, 309-d, 309-e, 309-f, 309-g, and 309-h. As noted, because UE 105 may also include an antenna array, it can receive RF reference signals transmitted by base stations 320-1 and 320-2 using beamforming to form respective receive beams (Rx beams) 311-a and 311-b. Beamforming in this manner (by base stations 320 and optionally by UEs 105) can be used to make communications more efficient. They can also be used for other purposes, including taking measurements for position determination (e.g., AoD and AoA measurements).

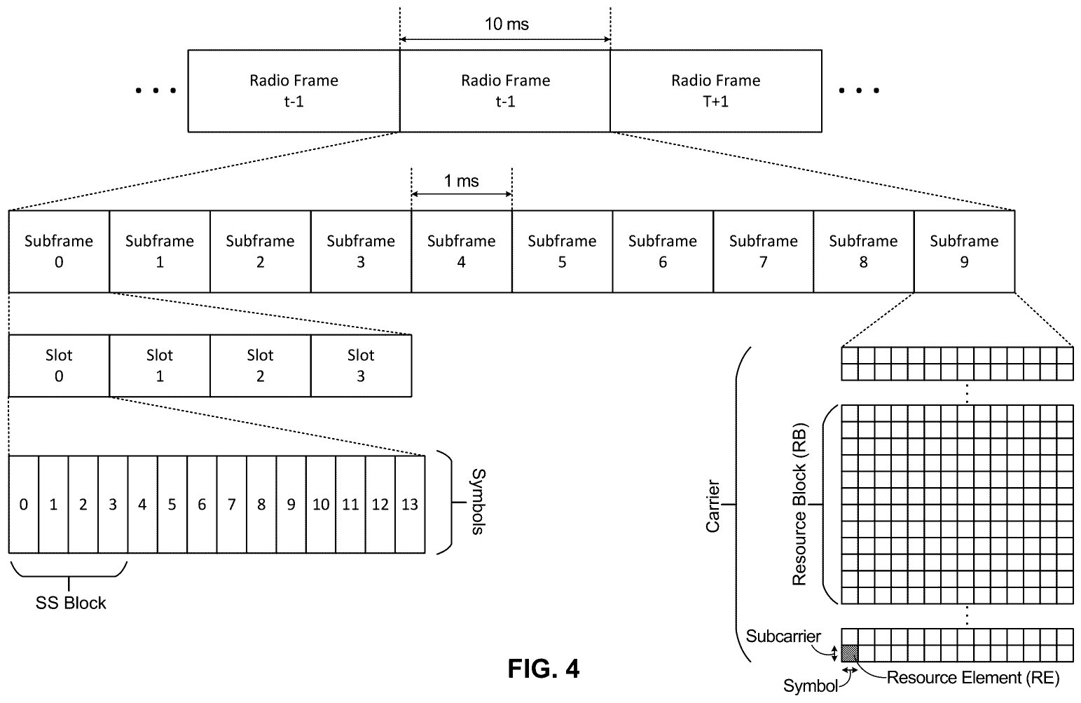

FIG. 4 is a diagram showing an example of a frame structure for NR and associated terminology, which can serve as the basis for physical layer communication between the UE 105 and base stations/TRPs. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 4 symbols). Additionally shown in FIG. 4 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

Each symbol in a slot may indicate a link direction (e.g., downlink (DL), uplink (UL), or flexible) or data transmission and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two symbol Physical Broadcast Channel (PBCH). The SS block can be transmitted in a fixed slot location, such as the symbols 0-3 as shown in FIG. 4. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

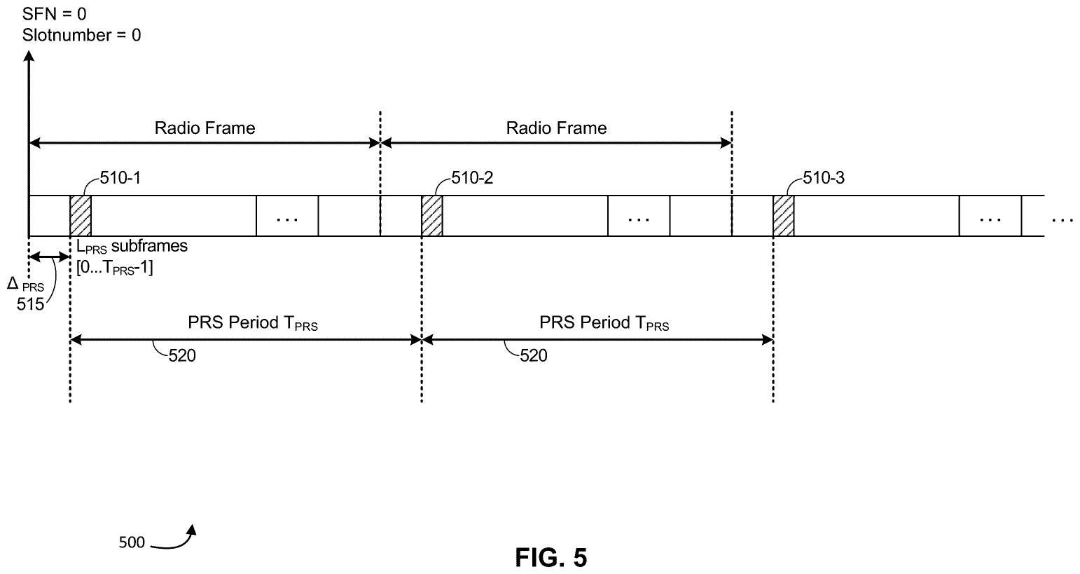

FIG. 5 is a diagram showing an example of a radio frame sequence 500 with PRS positioning occasions. A “PRS instance” or “PRS occasion” is one instance of a periodically repeated time window (e.g., a group of one or more consecutive slots) where PRS are expected to be transmitted. A PRS occasion may also be referred to as a “PRS positioning occasion,” a “PRS positioning instance, a “positioning occasion,” “a positioning instance,” or simply an “occasion” or “instance.” Subframe sequence 500 may be applicable to broadcast of PRS signals (DL-PRS signals) from base stations 120 in positioning system 100. The radio frame sequence 500 may be used in 5G NR (e.g., in 5G NR positioning system 200) and/or in LTE. Similar to FIG. 4, time is represented horizontally (e.g., on an X axis) in FIG. 5, with time increasing from left to right. Frequency is represented vertically (e.g., on a Y axis) with frequency increasing (or decreasing) from bottom to top.

FIG. 5 shows how PRS positioning occasions 510-1, 510-2, and 510-3 (collectively and generically referred to herein as positioning occasions 510) are determined by a System Frame Number (SFN), a cell-specific subframe offset (APRS) 515, a length or span of LPRS subframes, and the PRS Periodicity (T_{PRS}) 520. The cell-specific PRS subframe configuration may be defined by a “PRS Configuration Index,”/PRS, included in assistance data (e.g., TDOA, OTDOA, and/or FDOA assistance data), which may be defined by governing 3GPP standards. The cell-specific subframe offset (APRS) 515 may be defined in terms of the number of subframes transmitted starting from System Frame Number (SFN) 0 to the start of the first (subsequent) PRS positioning occasion.

A PRS may be transmitted by wireless nodes (e.g., base stations 120) after appropriate configuration (e.g., by an Operations and Maintenance (O&M) server). A PRS may be transmitted in special positioning subframes or slots that are grouped into positioning occasions 510. For example, a PRS positioning occasion 510-1 can comprise a number NPRS of consecutive positioning subframes where the number NPRS may be between 1 and 160 (e.g., may include the values 1, 2, 4 and 6 as well as other values). PRS occasions 510 may be grouped into one or more PRS occasion groups. As noted, PRS positioning occasions 510 may occur periodically at intervals, denoted by a number T_{PRS}, of millisecond (or subframe) intervals where T_{PRS} may equal 5, 10, 20, 40, 80, 160, 320, 640, or 1280 (or any other appropriate value). In some embodiments, T_{PRS} may be measured in terms of the number of subframes between the start of consecutive positioning occasions.

In some embodiments, when a UE 105 receives a PRS configuration index I_{PRS} in the assistance data for a particular cell (e.g., base station), the UE 105 may determine the PRS periodicity T_{PRS} 520 and cell-specific subframe offset (APRS) 515 using stored indexed data. The UE 105 may then determine the radio frame, subframe, and slot when a PRS is scheduled in the cell. The assistance data may be determined by, for example, a location server (e.g., location server 160 in FIG. 1 and/or LMF 220 in FIG. 2), and includes assistance data for a reference cell, and a number of neighbor cells supported by various wireless nodes.

Typically, PRS occasions from all cells in a network that use the same frequency are aligned in time and may have a fixed known time offset (e.g., cell-specific subframe offset (Δ_{PRS}) 515) relative to other cells in the network that use a different frequency. In SFN-synchronous networks all wireless nodes (e.g., base stations 120) may be aligned on both frame boundary and system frame number. Therefore, in SFN-synchronous networks all cells supported by the various wireless nodes may use the same PRS configuration index for any particular frequency of PRS transmission. On the other hand, in SFN-asynchronous networks, the various wireless nodes may be aligned on a frame boundary, but not system frame number. Thus, in SFN-asynchronous networks the PRS configuration index for each cell may be configured separately by the network so that PRS occasions align in time. A UE 105 may determine the timing of the PRS occasions 510 of the reference and neighbor cells for TDOA, OTDOA, and/or FDOA positioning, if the UE 105 can obtain the cell timing (e.g., SFN or Frame Number) of at least one of the cells, e.g., the reference cell or a serving cell. The timing of the other cells may then be derived by the UE 105 based, for example, on the assumption that PRS occasions from different cells overlap.

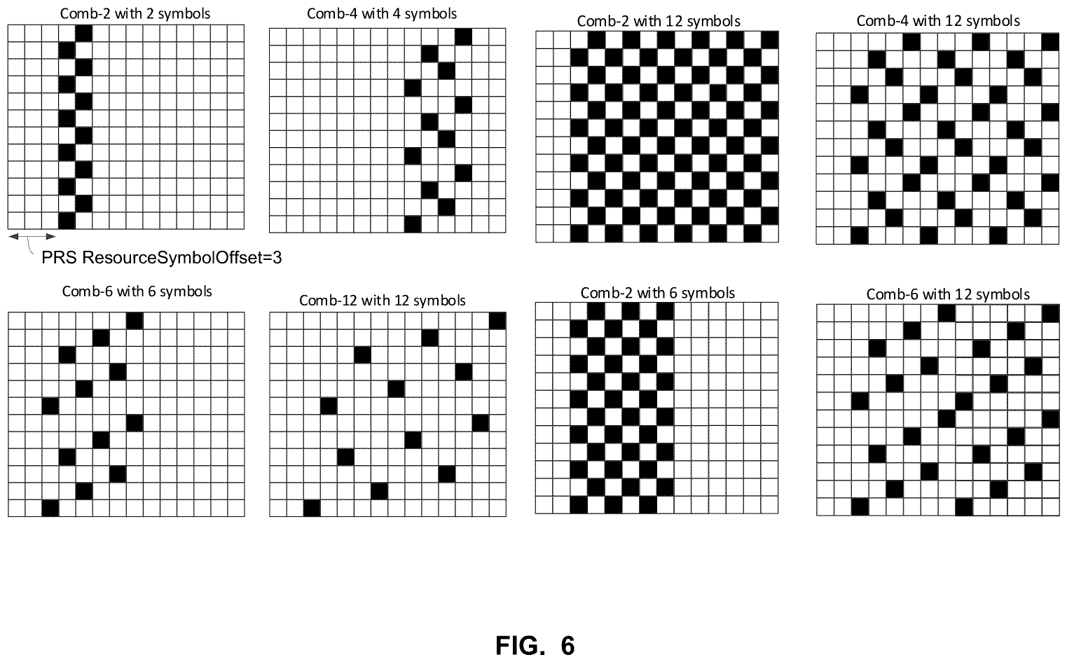

With reference to the frame structure in FIG. 4, a collection of REs that are used for transmission of PRS is referred to as a “PRS resource.” The collection of resource elements can span multiple RBs in the frequency domain and one or more consecutive symbols within a slot in the time domain, inside which pseudo-random Quadrature Phase Shift Keying (QPSK) sequences are transmitted from an antenna port of a TRP. In a given OFDM symbol in the time domain, a PRS resource occupies consecutive RBs in the frequency domain. The transmission of a PRS resource within a given RB has a particular combination, or “comb,” size. (Comb size also may be referred to as the “comb density.”) A comb size “N” represents the subcarrier spacing (or frequency/tone spacing) within each symbol of a PRS resource configuration, where the configuration uses every Nth subcarrier of certain symbols of an RB. For example, for comb-4, for each of the four symbols of the PRS resource configuration, REs corresponding to every fourth subcarrier (e.g., subcarriers 0, 4, 8) are used to transmit PRS of the PRS resource. Comb sizes of comb-2, comb-4, comb-6, and comb-12, for example, may be used in PRS. Examples of different comb sizes using with different numbers of symbols are provided in FIG. 6.

A “PRS resource set” comprises a group of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a cell ID). A “PRS resource repetition” is a repetition of a PRS resource during a PRS occasion/instance. The number of repetitions of a PRS resource may be defined by a “repetition factor” for the PRS resource. In addition, the PRS resources in a PRS resource set may have the same periodicity, a common muting pattern configuration, and the same repetition factor across slots. The periodicity may have a length selected from 2^{m}. {4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set may be associated with a single beam (and/or beam ID) transmitted from a single TRP (where a TRP may transmit one or more beams). That is, each PRS resource of a PRS resource set may be transmitted on a different beam, and as such, a PRS resource (or simply “resource”) can also be referred to as a “beam.” Note that this does not have any implications on whether the TRPs and the beams on which PRS are transmitted are known to the UE.

In the 5G NR positioning system 200 illustrated in FIG. 2, a TRP (gNB 210, ng-eNB 214, and/or WLAN 216) may transmit frames, or other physical layer signaling sequences, supporting PRS signals (i.e. a DL-PRS) according to frame configurations as previously described, which may be measured and used for position determination of the UE 105. As noted, other types of wireless network nodes, including other UEs, may also be configured to transmit PRS signals configured in a manner similar to (or the same as) that described above. Because transmission of a PRS by a wireless network node may be directed to all UEs within radio range, the wireless network node may be considered to transmit (or broadcast) a PRS.

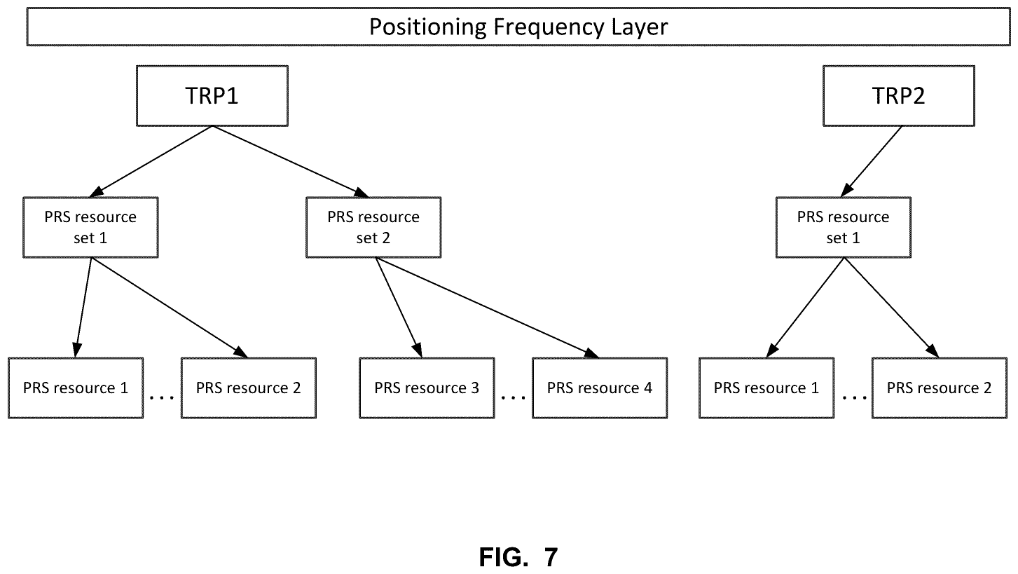

FIG. 7 is a diagram of a hierarchical structure of how PRS resources and PRS resource sets may be used by different TRPs of a given position frequency layer (PFL), as defined in 5G NR. With respect to a network (Uu) interface, a UE 105 can be configured with one or more DL-PRS resource sets from each of one or more TRPs. Each DL-PRS resource set includes K≥1 DL-PRS resource(s), which, as previously noted, may correspond to a Tx beam of the TRP. A DL-PRS PFL is defined as a collection of DL-PRS resource sets which have the same subcarrier spacing (SCS) and cyclic prefix (CP) type, the same value of DL-PRS bandwidth, the same center frequency, and the same value of comb size. In current iterations of the NR standard, a UE 105 can be configured with up to four DL-PRS PFLs.

NR has multiple frequency bands across different frequency ranges (e.g., Frequency Range 1 (FR1) and Frequency Range 2 (FR2)). PFLs may be on the same band or different bands. In some embodiments, they may even be in different frequency ranges. Additionally, as illustrated in FIG. 7, multiple TRPs (e.g., TRP1 and TR2) may be on the same PFL. Currently under NR, each TRP can have up to two PRS resource sets, each with one or more PRS resources, as previously described.

Different PRS resource sets may have different periodicity. For example, one PRS resource set may be used for tracking, and another PRS resource that could be used for acquisition. Additionally or alternatively, one PRS resource set may have more beams, and another may have fewer beams. Accordingly, different resource sets may be used by a wireless network for different purposes.

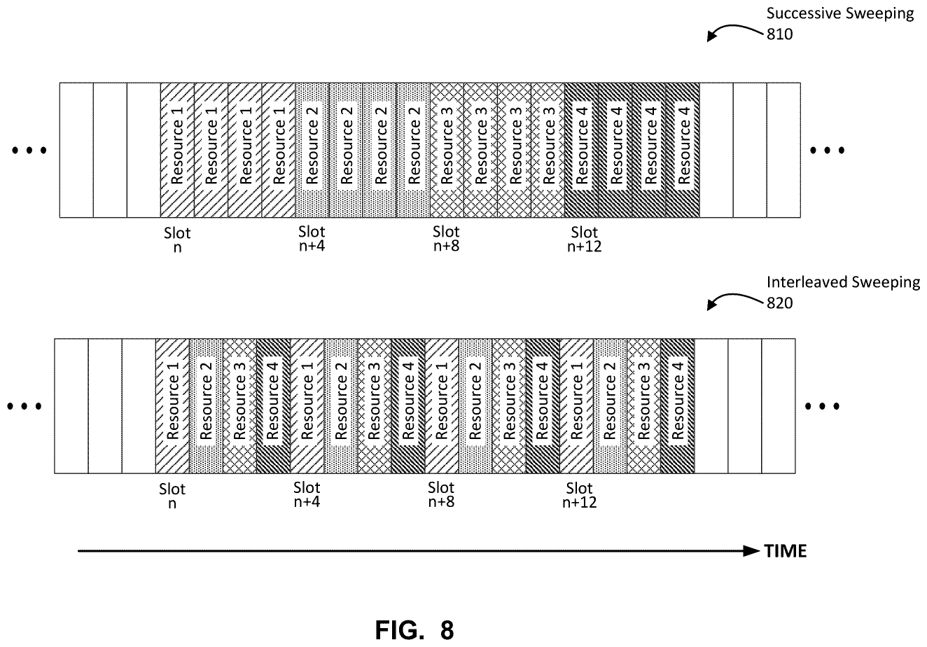

FIG. 8 is a time diagram illustrating two different options for slot usage of a resource set, according to an embodiment. Because each example repeats each resource four times, the resource set is said to have a repetition factor of four. Successive sweeping 810 comprises repeating a single resource (resource 1, resource 2, etc.) four times before proceeding to a subsequent resource. In this example, if each resource corresponds to a different beam of a TRP, the TRP repeats a beam for four slots in a row before moving to the next beam. Because each resource is repeated in successive slots (e.g., resource 1 is repeated in slots n, n+1, n+2, etc.), the time gap is said to be one slot. On the other hand, for interleaved sweeping 820, the TRP may move from one beam to the next for each subsequent slot, rotating through four beams for four rounds. Because each resource is repeated every four slots (e.g., resource 1 is repeated in slots n, n+4, n+8, etc.), the time gap is said to be one slot. Of course, embodiments are not so limited. Resource sets may comprise a different amount of resources and/or repetitions. Moreover, as noted above, each TRP may have multiple resource sets, multiple TRPs may utilize a single FL, and a UE may be capable of taking measurements of PRS resources transmitted via multiple FLs.

Thus, to obtain PRS measurements from PRS signals sent by TRPs and/or UEs in a network, the UE can be configured to observe PRS resources during a period of time called a measurement period. That is, to determine a position of the UE using PRS signals, a UE and a location server (e.g., LMF 220 of FIG. 2) may initiate a location session in which the UE is given a period of time to observe PRS resources and report resulting PRS measurements to the location server. As described in more detail below, this measurement period may be determined based on the capabilities of the UE.

To measure and process PRS resources during the measurement period, a UE can be configured to execute a measurement gap (MG) pattern. The UE can request a measurement gap from a serving TRP, for example, which can then provide the UE with the configuration (e.g., via Radio Resource Control (RRC) protocol).

As noted, a UE may be configured to execute an MG pattern to measure and process PRS resources of a PRS resource set outside an active DL bandwidth part (BWP) via which the UE sends and receives data with a serving TRP. To allow the network to configure the UE in a manner that accommodates the processing and buffering capabilities of the UE (which may be dynamic), the UE may provide to the network (e.g., a TRP or location server) capabilities related to PRS processing. The various parameters of the MG pattern can be configured in view of these capabilities.

As discussed herein, in some embodiments, TDOA, OTDOA, and/or FDOA assistance data may be provided to a UE 105 by a location server (e.g., location server 160) for a “reference cell” (which also may be called “reference resource”), and one or more “neighbor cells” or “neighboring cells” (which also may be called a “target cell” or “target resource”), relative to the reference cell. For example, the assistance data may provide the center channel frequency of each cell, various PRS configuration parameters (e.g., NPRS, T_{PRS}, muting sequence, frequency hopping sequence, PRS ID, PRS bandwidth), a cell global ID, PRS signal characteristics associated with a directional PRS, carrier phase characteristics associated with a phase-difference measurement (e.g., for FDOA), and/or other cell related parameters applicable to TDOA, OTDOA, FDOA, or some other position method, or a combination thereof. PRS-based positioning by a UE 105 may be facilitated by indicating the serving cell for the UE 105 in the TDOA assistance data (e.g., with the reference cell indicated as being the serving cell).

In some embodiments, TDOA assistance data may also include “expected Reference Signal Time Difference (RSTD)” parameters, which provide the UE 105 with information about the RSTD values the UE 105 is expected to measure at its current location between the reference cell and each neighbor cell, together with an uncertainty of the expected RSTD parameter. The expected RSTD, together with the associated uncertainty, may define a search window for the UE 105 within which the UE 105 is expected to measure the RSTD value. TDOA assistance information may also include PRS configuration information parameters, which allow a UE 105 to determine when a PRS positioning occasion occurs on signals received from various neighbor cells relative to PRS positioning occasions for the reference cell, and to determine the PRS sequence transmitted from various cells in order to measure a signal ToA or RSTD.

Using the RSTD measurements, the known absolute or relative transmission timing of each cell, and the known position(s) of wireless node physical transmitting antennas for the reference and neighboring cells, the UE position may be calculated (e.g., by the UE 105 or by the location server 160). More particularly, the RSTD for a neighbor cell “k” relative to a reference cell “Ref,” may be given as (ToAₖ-ToA_{Ref}), where the ToA values may be measured modulo one subframe duration (1 ms) to remove the effects of measuring different subframes at different times. ToA measurements for different cells may then be converted to RSTD measurements and sent to the location server 160 by the UE 105. Using (i) the RSTD measurements, (ii) the known absolute or relative transmission timing of each cell, (iii) the known position(s) of physical transmitting antennas for the reference and neighboring cells, and/or (iv) directional PRS characteristics such as a direction of transmission, the UE 105 position may be determined.

As part of a positioning session with a location server (e.g., LMF 220), the UE may exchange various data with a location server and receive assistance data from the location server comprising a PRS configuration indicating PRS resources with which the UE is to perform measurements during the positioning session. Because the UE may be incapable of processing all PRS resources in the PRS configuration, it may process only a portion of them. However, the PRS configuration provides PRS resources in an order of measurement priority. That is, the PFLs, TRPS, resource sets, and resources (e.g., as illustrated in FIG. 7) provided in an order within the PRS configuration that makes the measurement priority of each PRS resource unambiguous. Thus, if the UE is incapable of performing measurements using all PRS resources, it may select the PRS resources with which to perform measurements based on priority. If the UE is capable of using only five PRS resources for processing, it may therefore select the five PRS resources having the highest priority. Again, because of the prioritization of the PRS resources in the PRS configuration, the PRS resources to select for performing measurements is unambiguous to the UE.

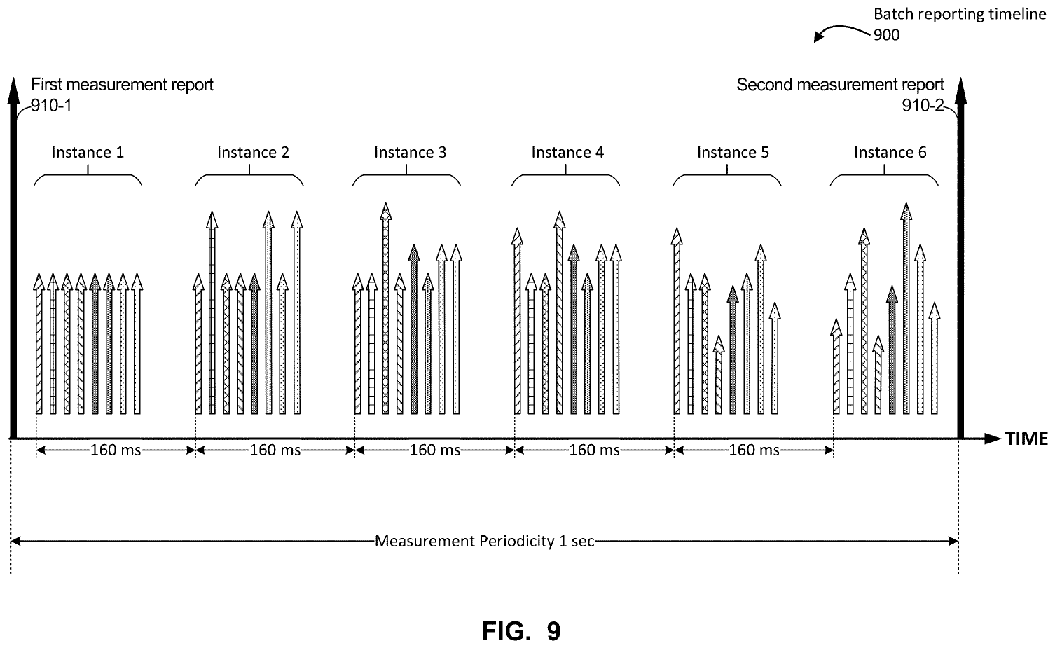

When reporting measurement information to the location server, however, there is no equivalent prioritization. This can lead to ambiguities in measurement reporting when performing batch reporting. Additional details are provided with respect to FIG. 9.

FIG. 9 is a graph illustrating an example of a batch reporting timeline 900 for a UE, according to an embodiment. (Base stations/TRPs may be configured in a similar manner and have a similar timeline.) As previously noted with respect to FIG. 5, PRS positioning occasions (or instances) may repeat periodically with a PDS periodicity of T_{PRS}. In the example in FIG. 9, this periodicity is 160 ms. (Alternative embodiments may use a different periodicity, as previously described.) A location server may configure a UE to measure multiple instances of PRS resources transmitted during a measurement window and provide a “batch” report of all PRS measurements performed within the window of time. The location server can use batch reporting as a tool to help reduce signaling. According to some embodiments, the location server may configure UEs and base stations participating in a positioning session with the same or similar measurement windows for batch reporting. As further indicated in the batch reporting timeline 900, the measurement window may span a duration of time on the order of one second (or more), and measurement windows and corresponding measurement reports may occur periodically.

In the example illustrated in FIG. 9, after providing a first measurement report 910-1 comprising measurements from an earlier measurement window (not shown), the UE performs measurements of eight PRS resources (represented as differently-shaded arrows) across six instances that repeat with the periodicity of 160 ms across a measurement window spending a duration of one second. After the measurement window, the UE will then provide the location server with measurements taken during the measurement window in a second measurement report 910-2 (represented in FIG. 9 as an arrow on the timeline indicating when the second measurement report is transmitted). Each measurement in the second measurement report 910-2 can include a timestamp to indicate a time at which the measurement was performed.

Currently, governing 3GPP standards limit the amount of measurements provided in a batch report to 256. If there are more than 256 measurements, the UE can decide which measurements to provide (e.g., the most recent 256 measurements, the best 256 measurements, etc.). As previously noted, because there is no prioritization in measurement reporting, this can lead to ambiguity regarding which measurements were taken. This may be especially the case for reporting of measurements where reference PRS resources are used.

As previously noted, a UE may use a reference signal to perform a measurement. For example, the UE may determine the timing of PRS occasions for reference and neighbor cells for TDOA, OTDOA, or FDOA positioning, or a combination thereof. To facilitate TDOA, OTDOA, or FDOA positioning, or a combination thereof, a location server may provide an indication in a PRS configuration of which PRS resources (herein referred to as “reference PRS resources”) to use as a reference in TDOA, OTDOA, and/or FDOA measurements. The location server may, for example, provide up to 64 reference PRS resources in assistance data provided to a UE, any of which can be used as a reference resource over the course of a measurement window. For positioning session in which there are 100 PRS resources (in addition to reference resources) for a UE to measure, the UE may use any of the 64 reference PRS resources, leading to 6400 (100×64) possible measurements the UE could take each instance. However, governing 3GPP standards limit reporting to a single reference PRS resource per report. This means that, even for batch reporting, a UE is limited to using a single reference PRS resource for all measurements taken during a measurement window because there currently is no way of indicating which reference PRS resources used on a per-measurement basis.

This limitation can be problematic in various situations, such as when the quality of PRS resources changes between instances of a measurement window. Returning to FIG. 9, for example, the eight differently-shaded arrows in each instance represent eight different PRS resources measured by the UE. The height of each arrow represents relative quality of the respective PRS resource as compared with the normalized quality in the first instance. As can be seen, the quality of each PRS resource may vary from instance to instance. This may be the case, for example, if the UE is moving. As such, it may not be desirable (or even possible) that a UE can use a single reference PRS resource for all instances for the duration of the measurement window (which can span for several seconds).

Embodiments provided herein address these and other issues by enabling the UE to select a best reference PRS resource to use in a batch reporting mode and/or select multiple reference PRS resources to use during a measurement window for batch reporting. Embodiments further enable reporting of such selection (including the use of multiple reference PRS resources) to a location server.

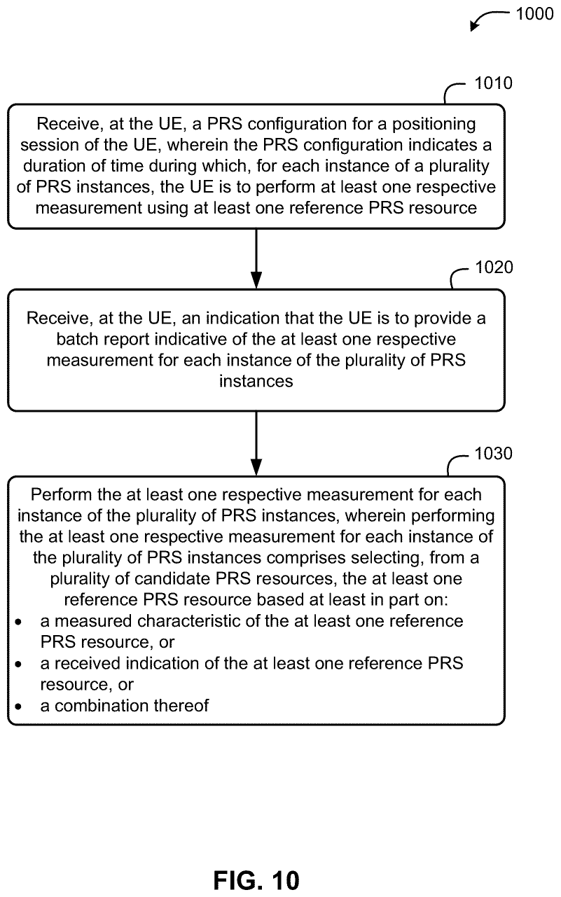

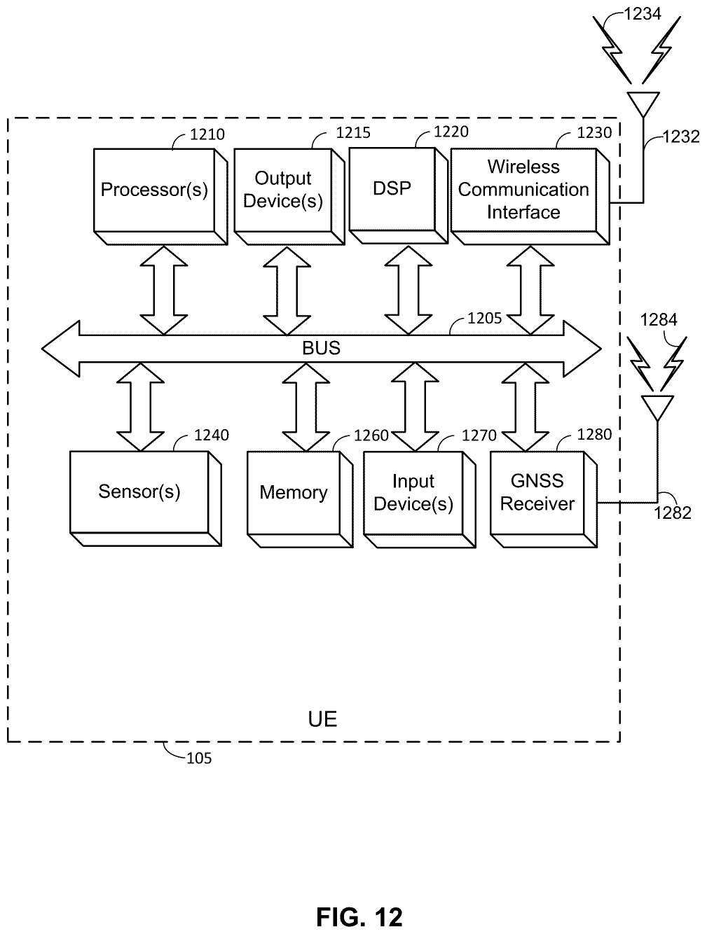

FIG. 10 is a flow diagram of a method 1000 of selecting a reference signal for positioning of a UE, according to an embodiment. Means for performing the functionality illustrated in one or more of the blocks shown in FIG. 10 may be performed by hardware and/or software components of a UE. Example components of a UE are illustrated in FIG. 12, which is described in more detail below.

At block 1010, the functionality comprises receiving, at the UE, a PRS configuration for a positioning session of the UE, wherein the PRS configuration indicates a duration of time during which, for each instance of a plurality of PRS instances, the UE is to perform at least one respective measurement using at least one reference PRS resource. As illustrated in the example of FIG. 9 the duration of time may comprise a measurement window during which multiple PRS occasions or instances occur. The PRS configuration may also indicate the various PRS resources to be measured by the UE and/or PRS resources that may be used as reference PRS resources in measurements (e.g., TDOA, OTDOA, and/or FDOA measurements). The at least one respective measurement for each instance of the plurality of PRS instances may comprise a TDOA, OTDOA, and/or FDOA measurement. Means for performing functionality at block 1010 may comprise a bus, 1205 processor(s) 1210, digital signal processor (DSP) 1220, wireless communication interface 1230, memory 1260, and/or other components of a UE, as illustrated in FIG. 12 and described hereafter.

At block 1020, the functionality comprises receiving, at the UE, an indication that the UE is to provide a batch report indicative of the at least one respective measurement for each instance of the plurality of PRS instances. As previously indicated, the syndication may be provided by a location server during a positioning session of the UE, and may be provided in a PRS configuration. Means for performing functionality at block 1020 may comprise a bus, 1205 processor(s) 1210, digital signal processor (DSP) 1220, wireless communication interface 1230, memory 1260, and/or other components of a UE, as illustrated in FIG. 12 and described hereafter.

At block 1030, the functionality comprises performing the at least one respective measurement for each instance of the plurality of PRS instances, wherein performing the at least one respective measurement for each instance of the plurality of PRS instances comprises selecting, from a plurality of candidate PRS resources, the at least one reference PRS resource based at least in part on a measured characteristic of the at least one reference PRS resource, or a received indication of the at least one reference PRS resource, or a combination thereof. As noted, the plurality of candidate PRS resources may be provided in the PRS configuration and/or another message to the UE from the location server. Means for performing functionality at block 1030 may comprise a bus 1205, processor(s) 1210, digital signal processor (DSP) 1220, wireless communication interface 1230, memory 1260, and/or other components of a UE, as illustrated in FIG. 12 and described hereafter.

Embodiments can incorporate one or more additional features, depending on desired functionality. For example, embodiments may further comprise providing the batch report to a location server, wherein the batch report includes an indication of the at least one reference PRS resource. In some embodiments, the at least one reference PRS resource comprises a single reference PRS resource, and wherein the batch report comprises a single message. In this case, embodiments may comply with existing governing standards in which a single reference PRS resources used for the entire duration of time (measurement window). In such instances, the UE may select the best reference PRS resource based on one or more quality metrics. As such, according to some embodiments, the measured characteristic of the at least one reference PRS resource may comprise a signal-to-noise ratio (SNR) value of an earliest arrival path of the at least one reference PRS resource, a minimum time of arrival (ToA) value of the at least one reference PRS resource, or a SNR value of a maximum peak of the at least one reference PRS resource, or a combination thereof. The UE can then report the reference PRS resource used in a reporting message (e.g., under current 3GPP standards, this message may comprise NR-DL-TDOA-SignalMeasurementInformation-r16).

According to some embodiments, multiple reference PRS resources may be used and subsequently reported by the UE. In such instances, the UE may select the best reference PRS resources (e.g., using the previously-described metrics, such as SNR value of the earliest arrival path, ToA value, etc.), up to a predefined number of selected reference PRS resources, for example. The UE may then perform the measurements (e.g., compute TDOA, OTDOA, and/or FDOA measurements with respect to the selected reference PRS resources), and report the measurements to a location server. According to some embodiments, the UE may report measurements using a first reference PRS resource using a first type of message (e.g., NR-DL-TDOA-MeasElement-r16), and report measurements using the additional reference PRS resources with respective messages having respective measurements using each additional PRS resource (e.g., NR-DL-TDOA-AdditionalMeasurements-r16). Thus, in an example in which the UE selects the four best reference PRS resources: Pref1, Pref2, Pref3, Pref4, the UE may send a first message of the first message type (e.g., NR-DL-TDOA-MeasElement-r16) that identifies reference PRS resource Pref1 and includes measurements using Pref1. The UE can then send three separate messages of a second message type (e.g., NR-DL-TDOA-AdditionalMeasurements-r16) corresponding to Pref2, Pref3, Pref4, in which each message identifies the respective reference PRS resource (Pref2, Pref3, or Pref4) in includes all measurements using that respective reference PRS resource. Thus, according to some embodiments of the method 1000 the at least one reference PRS resource may comprise a plurality of reference PRS resources, and wherein the batch report comprises a first message of a first message type and at least one additional message of a second message type. According to some embodiments, the method 1000 may further comprise selecting a reference PRS resource having a highest priority from the plurality of reference PRS resources, wherein the first message of the first message type corresponds to the reference PRS resource having the highest priority. Additionally or alternatively, each message of the first message type and the second message type may (i) correspond with a different respective reference PRS resource of the plurality of reference PRS resources, and (ii) include measurements using the respective reference PRS resource.

According to some embodiments, the UE may report the use of multiple reference PRS resources in a single message in which the UE is able to indicate which reference PRS resource is used for any given measurement. For example, a new information element (IE) may be defined in the NR-DL-TDOA-MeasElement-r16 message type (e.g., as currently defined in relevant 3GPP standards), where the IE is used to point the to reference PRS resources in NR-DL-TDOA-SignalMeasurementInformation-r16. Put more generally, after selecting the reference PRS resources to use, the UE may then assign a unique index number (e.g., an integer having a value between 0 and 8) to each reference PRS resource (e.g., in order of priority). In the reporting message, the UE can associate each measurement with the index number of the corresponding reference PRS resource used for the measurement, thereby allowing the location server to determine which reference PRS resource is used for each measurement. With this in mind, for some embodiments of the method 1000, at least one reference PRS resource may comprise a plurality of reference PRS resources, and wherein the batch report comprises a single message. Further, for each measurement included in the batch report, the measurement may be associated with an identifier of a corresponding reference PRS resource used for the measurement. According to some embodiments, the identifier of the corresponding reference PRS resource comprises an index number assigned to the corresponding reference PRS resource in the batch report.

According to some embodiments, the location server can provide an indication to the UE of which reference PRS resources to use at which times. This can be based, for example, on the location server's knowledge of the movement of the UE within locations corresponding to different base stations/beams. For example, if the location server can determine, based on current and/or past movement of the UE that the UE is likely to travel from beam 1 of base station A to beam 3 of base station B during the course of a measurement window, the location server can indicate to the UE to first use the reference PRS resource corresponding to beam 1 of base station A, then switch to the reference PRS resource corresponding to beam 3 of base station B at a time when the location server estimates the UE is likely to transition from beam 1 of base station A to beam 3 of base station B. Depending on desired functionality, this indication may be provided by the location server to the UE in the PRS configuration, another message, on-the-fly (e.g., as the location server tracks the movement of the UE), or any combination thereof, over the course of the positioning session with a UE. With this in mind, according to some embodiments of the method 1000, the received indication may be received from the location server. Additionally or alternatively, the received indication may indicate different reference PRS resources to use for different PRS instances of the plurality of PRS instances. Again, this may be based on known movements of the UE compared with known areas associated with different reference PRS resources.

Embodiments further may include additional or alternative functions. According to some embodiments of the method 1000, for example, the plurality of candidate PRS resources may be provided in the PRS configuration. They may be flagged, for example, by the location server as candidate PRS resources that may be used as reference PRS resources. In some embodiments, the at least one reference PRS resource used by the UE in other measurement windows throughout the positioning session. Accordingly, some embodiments of the method 1000 may further comprise performing additional measurements for the positioning session during a second duration of time using the at least one reference PRS resource.

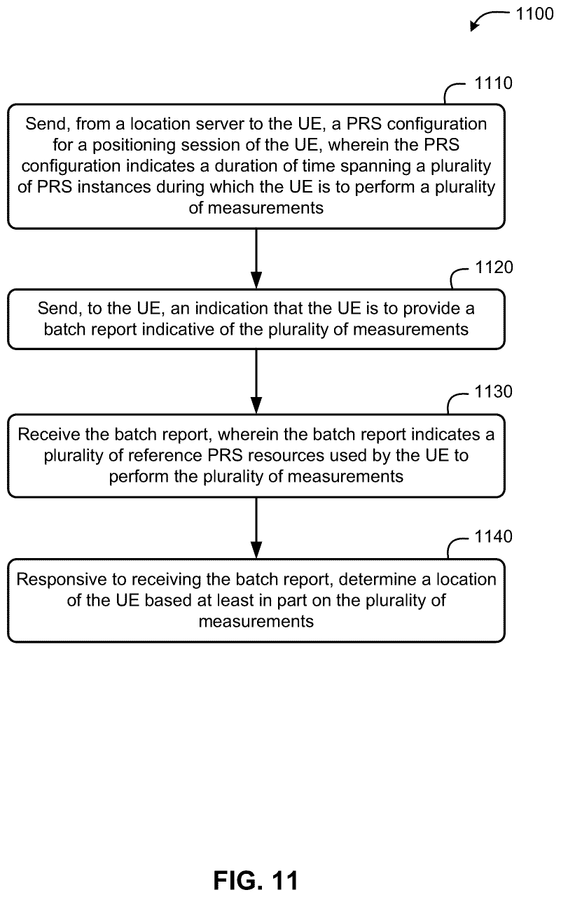

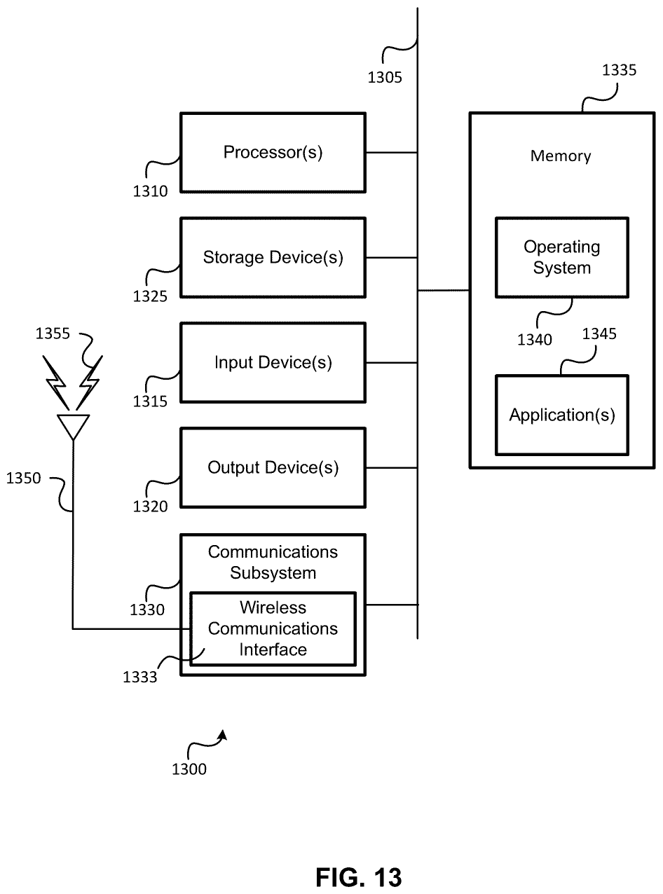

FIG. 11 is a flow diagram of a method 1100 of selecting a reference signal for positioning of a UE, according to an embodiment. Some aspects of the method 1100 of FIG. 11 may correspond with the functionality of the location server when interacting with a UE performing the method 1000 of FIG. 10. Means for performing the functionality illustrated in one or more of the blocks shown in FIG. 11 may be performed by hardware and/or software components of a computer system. Example components of a computer system are illustrated in FIG. 13, which is described in more detail below.

At block 1110, the functionality comprises sending, from a location server to the UE, a positioning reference signal (PRS) configuration for a positioning session of the UE, wherein the PRS configuration indicates a duration of time spanning a plurality of PRS instances during which the UE is to perform a plurality of measurements. As noted, other aspects of the PRS configuration may comprise defining one or more PFLs, TRPS, PRS resource sets, and PRS resources, as previously described with regard to FIG. 7. As noted, according to some embodiments, the location server may further indicate candidate PRS resources for use as reference PRS resources by the UE. Accordingly, some embodiments of the method 1100 may further comprise including, in the PRS configuration, a plurality of candidate PRS resources from which the plurality of reference PRS resources were selected by the UE. Means for performing functionality at block 1110 may comprise a bus, 1305 processor(s) 1310, communications subsystem 1330, memory 1335, operating system 1340, application(s) 1345, and/or other components of a computer system, as illustrated in FIG. 13 and described hereafter.

At block 1120, the functionality comprises sending, to the UE, an indication that the UE is to provide a batch report indicative of the plurality of measurements. As previously noted in the above-described embodiments, this indication may be included in the PRS configuration provided to the UE. Additionally or alternatively, this indication may be provided separately by the location server, for example, during the course of a positioning session. As previously indicated, the location server may decide to configure the UE four batch reporting to help reduce signaling (e.g., in response to heavy wireless bandwidth usage, for example). Means for performing functionality at block 1120 may comprise a bus, 1305 processor(s) 1310, communications subsystem 1330, memory 1335, operating system 1340, application(s) 1345, and/or other components of a computer system, as illustrated in FIG. 13 and described hereafter.

At block 1130, the functionality comprises receiving the batch report, wherein the batch report indicates a plurality of reference PRS resources used by the UE to perform the plurality of measurements. As noted, the batch report may be received in various ways, depending on desired functionality. For example, according to some embodiments, the batch report may comprise a first message of a first message type (e.g., NR-DL-TDOA-MeasElement-r16) and at least one additional message of a second message type (e.g., NR-DL-TDOA-AdditionalMeasurements-r16). Further, messages may be provided in order of priority. For example, a reference PRS resource having a highest priority from the plurality of reference PRS resources may be included in the first message. According to some embodiments, each message of the first message type and the second message type may (i) correspond with a different respective reference PRS resource of the plurality of reference PRS resources, and (ii) include measurements using the respective reference PRS resource. According to some embodiments, the batch report may comprise a single message. In such embodiments, for each measurement included in the batch report, the measurement may be associated with an identifier of a corresponding reference PRS resource used for the measurement. The identifier of the corresponding reference PRS resource may comprise an index number assigned to the corresponding reference PRS resource in the batch report.

As noted, according to some embodiments, the location server can indicate to the UE which PRS resources use as reference PRS resources. In particular, the location server can configure the UE (e.g., via the PRS configuration and/or another configuration provided during a positioning session, some of which may be provided on the fly, for example) to use particular reference PRS resources at particular PRS instances. For example, the location server can indicate to the UE to use resource P1 at time T1 (which may be a time from the start of a measurement window, and instance number, etc.), use resource P2 at time T2, etc. As previously noted, this may be based on a determination of UE movement (e.g., based on current and/or past movement of the UE). In some embodiments, the location server may ask the UE to perform an average over multiple reference PRS resources. In some embodiments, the location server may add new/different reference PRS resources and/or resource sets in the assistance data for different future timestamps. With this functionality in mind, the method 1100 may further comprise, prior to receiving the batch report, indicating different reference PRS resources of the plurality of reference PRS resources to use for different PRS instances of the plurality of PRS instances. According to some embodiments, the method 1100 may comprise determining the different reference PRS resources of the plurality of reference PRS resources to use for the different PRS instances of the plurality of PRS instances based at least in part on determined movement of the UE.

Means for performing functionality at block 1130 may comprise a bus, 1305 processor(s) 1310, communications subsystem 1330, memory 1335, operating system 1340, application(s) 1345, and/or other components of a computer system, as illustrated in FIG. 13 and described hereafter.

At block 1140, the functionality comprises, responsive to receiving the batch report, determining a location of the UE based at least in part on the plurality of measurements. This determination may be made using measurements provided in the batch report, along with measurements provided by other entities, such as other UEs, TRPs/base stations, etc. in some embodiments, the UE may provide different types of measurements (including measurements that do not use reference PRS resources) in the batch report and/or separate reports provided during the positioning session. Means for performing functionality at block 1140 may comprise a bus, 1305 processor(s) 1310, communications subsystem 1330, memory 1335, operating system 1340, application(s) 1345, and/or other components of a computer system, as illustrated in FIG. 13 and described hereafter.

FIG. 12 is a block diagram of an embodiment of a UE 105, which can be utilized as described herein above (e.g., in association with FIGS. 1-11). For example, the UE 105 can perform one or more of the functions of the method shown in FIG. 10. It should be noted that FIG. 12 is meant only to provide a generalized illustration of various components, any or all of which may be utilized as appropriate. It can be noted that, in some instances, components illustrated by FIG. 12 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 12.

The UE 105 is shown comprising hardware elements that can be electrically coupled via a bus 1205 (or may otherwise be in communication, as appropriate). The hardware elements may include a processor(s) 1210 which can include without limitation one or more general-purpose processors (e.g., an application processor), one or more special-purpose processors (such as DSP chips, graphics acceleration processors, application specific integrated circuits (ASICs), and/or the like), and/or other processing structures or means. Processor(s) 1210 may comprise one or more processing units, which may be housed in a single integrated circuit (IC) or multiple ICs. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below). The UE 105 also can include one or more input devices 1270, which can include without limitation one or more keyboards, touch screens, touch pads, microphones, buttons, dials, switches, and/or the like; and one or more output devices 1215, which can include without limitation one or more displays (e.g., touch screens), light emitting diodes (LEDs), speakers, and/or the like.

The UE 105 may also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1230 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1232 that send and/or receive wireless signals 1234. According to some embodiments, the wireless communication antenna(s) 1232 may comprise a plurality of discrete antennas, antenna arrays, or any combination thereof. The antenna(s) 1232 may be capable of transmitting and receiving wireless signals using beams (e.g., Tx beams and Rx beams). Beam formation may be performed using digital and/or analog beam formation techniques, with respective digital and/or analog circuitry. The wireless communication interface 1230 may include such circuitry.

Depending on desired functionality, the wireless communication interface 1230 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1240. Sensor(s) 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1280 capable of receiving signals 1284 from one or more GNSS satellites using an antenna 1282 (which could be the same as antenna 1232). Positioning based on GNSS signal measurement can be utilized to complement and/or incorporate the techniques described herein. The GNSS receiver 1280 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1280 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1280 is illustrated in FIG. 12 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1210, DSP 1220, and/or a processor within the wireless communication interface 1230 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 1210 or DSP 1220.

The UE 105 may further include and/or be in communication with a memory 1260. The memory 1260 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the UE 105 also can comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the UE 105 (and/or processor(s) 1210 or DSP 1220 within UE 105). In some embodiments, then, such code and/or instructions can be used to configure and/or adapt a general-purpose computer (or other device) to perform one or more operations in accordance with the described methods.

FIG. 13 is a block diagram of an embodiment of a computer system 1300, which may be used, in whole or in part, to provide the functions of one or more network components as described in the embodiments herein (e.g., location server 160 of FIG. 1, LMF 220 of FIG. 2, etc.). As such, the computer system 1300 may be configured to perform some or all of the functions illustrated in the method 1100 of FIG. 11. It should be noted that FIG. 13 is meant only to provide a generalized illustration of various components, any or all of which may be utilized as appropriate. FIG. 13, therefore, broadly illustrates how individual system elements may be implemented in a relatively separated or relatively more integrated manner. In addition, it can be noted that components illustrated by FIG. 13 can be localized to a single device and/or distributed among various networked devices, which may be disposed at different geographical locations.

The computer system 1300 is shown comprising hardware elements that can be electrically coupled via a bus 1305 (or may otherwise be in communication, as appropriate). The hardware elements may include processor(s) 1310, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1300 also may comprise one or more input devices 1315, which may comprise without limitation a mouse, a keyboard, a camera, a microphone, and/or the like; and one or more output devices 1320, which may comprise without limitation a display device, a printer, and/or the like.

The computer system 1300 may further include (and/or be in communication with) one or more non-transitory storage devices 1325, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1300 may also include a communications subsystem 1330, which may comprise wireless communication technologies managed and controlled by a wireless communication interface 1333, as well as wired technologies (such as Ethernet, coaxial communications, universal serial bus (USB), and the like). The wireless communication interface 1333 may comprise one or more wireless transceivers that may send and receive wireless signals 1355 (e.g., signals according to 5G NR or LTE) via wireless antenna(s) 1350. Thus the communications subsystem 1330 may comprise a modem, a network card (wireless or wired), an infrared communication device, a wireless communication device, and/or a chipset, and/or the like, which may enable the computer system 1300 to communicate on any or all of the communication networks described herein to any device on the respective network, including a User Equipment (UE), base stations and/or other TRPs, and/or any other electronic devices described herein. Hence, the communications subsystem 1330 may be used to receive and send data as described in the embodiments herein.

In many embodiments, the computer system 1300 will further comprise a working memory 1335, which may comprise a RAM or ROM device, as described above. Software elements, shown as being located within the working memory 1335, may comprise an operating system 1340, device drivers, executable libraries, and/or other code, such as one or more applications 1345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1325 described above. In some cases, the storage medium might be incorporated within a computer system, such as computer system 1300. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1300 and/or might take the form of source and/or installable code, which, upon compilation and/or installation on the computer system 1300 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of selecting a reference signal for positioning of a user equipment (UE), the method comprising: receiving, at the UE, a positioning reference signal (PRS) configuration for a positioning session of the UE, wherein the PRS configuration indicates a duration of time during which, for each instance of a plurality of PRS instances, the UE is to perform at least one respective measurement using at least one reference PRS resource; receiving, at the UE, an indication that the UE is to provide a batch report indicative of the at least one respective measurement for each instance of the plurality of PRS instances; and performing the at least one respective measurement for each instance of the plurality of PRS instances, wherein performing the at least one respective measurement for each instance of the plurality of PRS instances comprises selecting, from a plurality of candidate PRS resources, the at least one reference PRS resource based at least in part on: a measured characteristic of the at least one reference PRS resource, or a received indication of the at least one reference PRS resource, or a combination thereof.

Clause 2. The method of clause 1, further comprising providing the batch report to a location server, wherein the batch report includes an indication of the at least one reference PRS resource.

Clause 3. The method of clause 2 wherein the at least one reference PRS resource comprises a single reference PRS resource, and wherein the batch report comprises a single message.

Clause 4. The method of clause 2 wherein the at least one reference PRS resource comprises a plurality of reference PRS resources, and wherein the batch report comprises a first message of a first message type and at least one additional message of a second message type.

Clause 5. The method of clause 4 further comprising selecting a reference PRS resource having a highest priority from the plurality of reference PRS resources, wherein the first message of the first message type corresponds to the reference PRS resource having the highest priority.

Clause 6. The method of any of clauses 4-5 wherein each message of the first message type and the second message type (i) corresponds with a different respective reference PRS resource of the plurality of reference PRS resources, and (ii) includes measurements using the respective reference PRS resource.

Clause 7. The method of any of clauses 2-6 wherein the at least one reference PRS resource comprises a plurality of reference PRS resources, and wherein the batch report comprises a single message.

Clause 8. The method of clause 7 wherein, for each measurement included in the batch report, the measurement is associated with an identifier of a corresponding reference PRS resource used for the measurement.

Clause 9. The method of any of clauses 7-8 wherein the identifier of the corresponding reference PRS resource comprises an index number assigned to the corresponding reference PRS resource in the batch report.

Clause 10. The method of any of clauses 7-9 wherein the received indication is received from the location server.

Clause 11. The method of any of clauses 7-10 wherein the received indication indicates different reference PRS resources to use for different PRS instances of the plurality of PRS instances.

Clause 12. The method of any of clauses 1-11 wherein the measured characteristic of the at least one reference PRS resource comprises: a signal-to-noise ratio (SNR) value of an earliest arrival path of the at least one reference PRS resource, a minimum time of arrival (ToA) value of the at least one reference PRS resource, or a SNR value of a maximum peak of the at least one reference PRS resource, or a combination thereof.

Clause 13. The method of any of clauses 1-12 wherein the plurality of candidate PRS resources is provided in the PRS configuration.

Clause 14. The method of any of clauses 1-13 wherein the at least one respective measurement for each instance of the plurality of PRS instances comprises a time difference of arrival (TDOA) measurement, an observed time difference of arrival (OTDOA), a frequency difference of arrival (FDOA), or a combination thereof.

Clause 15. The method of any of clauses 1-14 further comprising performing additional measurements for the positioning session during a second duration of time using the at least one reference PRS resource.

Clause 16. A method of supporting batch reporting of reference signals for positioning of a user equipment (UE), the method comprising: sending, from a location server to the UE, a positioning reference signal (PRS) configuration for a positioning session of the UE, wherein the PRS configuration indicates a duration of time spanning a plurality of PRS instances during which the UE is to perform a plurality of measurements; sending, to the UE, an indication that the UE is to provide a batch report indicative of the plurality of measurements; receiving the batch report, wherein the batch report indicates a plurality of reference PRS resources used by the UE to perform the plurality of measurements; and responsive to receiving the batch report, determining a location of the UE based at least in part on the plurality of measurements.

Clause 17. The method of clause 16, further comprising including, in the PRS configuration, a plurality of candidate PRS resources from which the plurality of reference PRS resources were selected by the UE.

Clause 18. The method of any of clauses 16-17 wherein the batch report comprises a first message of a first message type and at least one additional message of a second message type.

Clause 19. The method of clause 18 wherein a reference PRS resource having a highest priority from the plurality of reference PRS resources is included in the first message.

Clause 20. The method of any of clauses 16-19 wherein each message of the first message type and the second message type (i) corresponds with a different respective reference PRS resource of the plurality of reference PRS resources, and (ii) includes measurements using the respective reference PRS resource.

Clause 21. The method of any of clauses 16-17 wherein the batch report comprises a single message.

Clause 22. The method of any of clauses 16-21 wherein, for each measurement included in the batch report, the measurement is associated with an identifier of a corresponding reference PRS resource used for the measurement.

Clause 23. The method of clause 22 wherein the identifier of the corresponding reference PRS resource comprises an index number assigned to the corresponding reference PRS resource in the batch report.

Clause 24. The method of any of clauses 16-23 further comprising, prior to receiving the batch report, indicating different reference PRS resources of the plurality of reference PRS resources to use for different PRS instances of the plurality of PRS instances.

Clause 25. The method of clause 24 further comprising determining the different reference PRS resources of the plurality of reference PRS resources to use for the different PRS instances of the plurality of PRS instances based at least in part on determined movement of the UE.

Clause 26. A user equipment (UE) for selecting a reference signal for positioning of the UE, the UE comprising: a transceiver; a memory; and one or more processors communicatively coupled with the transceiver and the memory, wherein the one or more processors are configured to: receive, via the transceiver, a positioning reference signal (PRS) configuration for a positioning session of the UE, wherein the PRS configuration indicates a duration of time during which, for each instance of a plurality of PRS instances, the UE is to perform at least one respective measurement using at least one reference PRS resource; receive, via the transceiver, an indication that the UE is to provide a batch report indicative of the at least one respective measurement for each instance of the plurality of PRS instances; and perform the at least one respective measurement for each instance of the plurality of PRS instances, wherein performing the at least one respective measurement for each instance of the plurality of PRS instances comprises selecting, from a plurality of candidate PRS resources, the at least one reference PRS resource based at least in part on: a measured characteristic of the at least one reference PRS resource, or a received indication of the at least one reference PRS resource, or a combination thereof.

Clause 27. The UE of clause 26, wherein the one or more processors are further configured to provide the batch report to a location server, wherein the batch report includes an indication of the at least one reference PRS resource.

Clause 28. The UE of clause 27 wherein the at least one reference PRS resource comprises a single reference PRS resource, and wherein the batch report comprises a single message.

Clause 29. The UE of clause 27 wherein the at least one reference PRS resource comprises a plurality of reference PRS resources, and wherein the batch report comprises a first message of a first message type and at least one additional message of a second message type.

Clause 30. The UE of clause 29 wherein the one or more processors are further configured to select a reference PRS resource having a highest priority from the plurality of reference PRS resources, wherein the first message of the first message type corresponds to the reference PRS resource having the highest priority.

Clause 31. The UE of any of clauses 29-30 wherein each message of the first message type and the second message type (i) corresponds with a different respective reference PRS resource of the plurality of reference PRS resources, and (ii) includes measurements using the respective reference PRS resource.

Clause 32. The UE of any of clauses 27-31 wherein the at least one reference PRS resource comprises a plurality of reference PRS resources, and wherein the batch report comprises a single message.

Clause 33. The UE of clause 32 wherein, for each measurement included in the batch report, the measurement is associated with an identifier of a corresponding reference PRS resource used for the measurement.

Clause 34. The UE of any of clauses 32-33 wherein the identifier of the corresponding reference PRS resource comprises an index number assigned to the corresponding reference PRS resource in the batch report.

Clause 35. The UE of any of clauses 32-34 wherein the one or more processors are configured to receive the received indication from the location server.

Clause 36. The UE of any of clauses 32-35 wherein the received indication indicates different reference PRS resources to use for different PRS instances of the plurality of PRS instances.

Clause 37. The UE of any of clauses 26-36 wherein the measured characteristic of the at least one reference PRS resource comprises: a signal-to-noise ratio (SNR) value of an earliest arrival path of the at least one reference PRS resource, a minimum time of arrival (ToA) value of the at least one reference PRS resource, or a SNR value of a maximum peak of the at least one reference PRS resource, or a combination thereof.

Clause 38. The UE of any of clauses 26-37 wherein the plurality of candidate PRS resources is provided in the PRS configuration.

Clause 39. The UE of any of clauses 26-38 wherein the at least one respective measurement for each instance of the plurality of PRS instances comprises a time difference of arrival (TDOA) measurement, an observed time difference of arrival (OTDOA), a frequency difference of arrival (FDOA), or a combination thereof.

Clause 40. The UE of any of clauses 26-39 wherein the one or more processors are further configured to perform additional measurements for the positioning session during a second duration of time using the at least one reference PRS resource.

Clause 41. A location server for supporting batch reporting of reference signals for positioning of a user equipment (UE), the location server comprising: a transceiver; a memory; and one or more processors communicatively coupled with the transceiver and the memory, wherein the one or more processors are configured to: send, via the transceiver to the UE, a positioning reference signal (PRS) configuration for a positioning session of the UE, wherein the PRS configuration indicates a duration of time spanning a plurality of PRS instances during which the UE is to perform a plurality of measurements; send, via the transceiver to the UE, an indication that the UE is to provide a batch report indicative of the plurality of measurements; receive the batch report via the transceiver, wherein the batch report indicates a plurality of reference PRS resources used by the UE to perform the plurality of measurements; and responsive to receiving the batch report, determine a location of the UE based at least in part on the plurality of measurements.

Clause 42. The location server of clause 41, wherein the one or more processors are further configured to include, in the PRS configuration, a plurality of candidate PRS resources from which the plurality of reference PRS resources were selected by the UE.

Clause 43. The location server of any of clauses 41-42 wherein the batch report comprises a first message of a first message type and at least one additional message of a second message type.

Clause 44. The location server of clause 43 wherein a reference PRS resource having a highest priority from the plurality of reference PRS resources is included in the first message.

Clause 45. The location server of any of clauses 41-44 wherein each message of the first message type and the second message type (i) corresponds with a different respective reference PRS resource of the plurality of reference PRS resources, and (ii) includes measurements using the respective reference PRS resource.

Clause 46. The location server of any of clauses 41-42 wherein the one or more processors are configured to receive the batch report in a single message.

Clause 47. The location server of any of clauses 41-46 wherein, for each measurement included in the batch report, the measurement is associated with an identifier of a corresponding reference PRS resource used for the measurement.

Clause 48. The location server of clause 47 wherein the identifier of the corresponding reference PRS resource comprises an index number assigned to the corresponding reference PRS resource in the batch report.

Clause 49. The location server of any of clauses 41-48 wherein the one or more processors are further configured to, prior to receiving the batch report, indicate different reference PRS resources of the plurality of reference PRS resources to use for different PRS instances of the plurality of PRS instances.

Clause 50. The location server of clause 49 wherein the one or more processors are further configured to determine the different reference PRS resources of the plurality of reference PRS resources to use for the different PRS instances of the plurality of PRS instances based at least in part on determined movement of the UE.

Clause 51. An apparatus having means for performing the method of any one of clauses 1-25.

Clause 52. A non-transitory computer-readable medium storing instructions, the instructions comprising code for performing the method of any one of clauses 1-25.

What is claimed is:

1. A method of selecting a reference signal for positioning of a user equipment (UE), the method comprising:
receiving, at the UE, a positioning reference signal (PRS) configuration for a positioning session of the UE, wherein the PRS configuration indicates a duration of time during which, for each instance of a plurality of PRS instances, the UE is to perform at least one respective measurement using at least one reference PRS resource;
receiving, at the UE, an indication that the UE is to provide a batch report indicative of the at least one respective measurement for each instance of the plurality of PRS instances; and
performing the at least one respective measurement for each instance of the plurality of PRS instances, wherein performing the at least one respective measurement for each instance of the plurality of PRS instances comprises selecting, from a plurality of candidate PRS resources, the at least one reference PRS resource based at least in part on:
a measured characteristic of the at least one reference PRS resource, or
a received indication of the at least one reference PRS resource, or
a combination thereof.

2. The method of claim 1, further comprising providing the batch report to a location server, wherein the batch report includes an indication of the at least one reference PRS resource.

3. The method of claim 2, wherein the at least one reference PRS resource comprises a single reference PRS resource, and wherein the batch report comprises a single message.

4. The method of claim 2, wherein the at least one reference PRS resource comprises a plurality of reference PRS resources, and wherein the batch report comprises a first message of a first message type and at least one additional message of a second message type.

5. The method of claim 4, further comprising selecting a reference PRS resource having a highest priority from the plurality of reference PRS resources, wherein the first message of the first message type corresponds to the reference PRS resource having the highest priority.

6. The method of claim 4, wherein each message of the first message type and the second message type (i) corresponds with a different respective reference PRS resource of the plurality of reference PRS resources, and (ii) includes measurements using the respective reference PRS resource.

7. The method of claim 2, wherein the at least one reference PRS resource comprises a plurality of reference PRS resources, and wherein the batch report comprises a single message.

8. The method of claim 7, wherein, for each measurement included in the batch report, the measurement is associated with an identifier of a corresponding reference PRS resource used for the measurement.

9. The method of claim 7, wherein the received indication indicates different reference PRS resources to use for different PRS instances of the plurality of PRS instances.

10. The method of claim 1, wherein the measured characteristic of the at least one reference PRS resource comprises:
a signal-to-noise ratio (SNR) value of an earliest arrival path of the at least one reference PRS resource,
a minimum time of arrival (ToA) value of the at least one reference PRS resource, or
a SNR value of a maximum peak of the at least one reference PRS resource, or
a combination thereof.

11. The method of claim 1, wherein the at least one respective measurement for each instance of the plurality of PRS instances comprises a time difference of arrival (TDOA) measurement, an observed time difference of arrival (OTDOA), a frequency difference of arrival (FDOA), or a combination thereof.

12. A method of supporting batch reporting of reference signals for positioning of a user equipment (UE), the method comprising:
sending, from a location server to the UE, a positioning reference signal (PRS) configuration for a positioning session of the UE, wherein the PRS configuration indicates a duration of time spanning a plurality of PRS instances during which the UE is to perform a plurality of measurements;
sending, to the UE, an indication that the UE is to provide a batch report indicative of the plurality of measurements;
receiving the batch report, wherein the batch report indicates a plurality of reference PRS resources used by the UE to perform the plurality of measurements; and
responsive to receiving the batch report, determining a location of the UE based at least in part on the plurality of measurements.

13. The method of claim 12, further comprising including, in the PRS configuration, a plurality of candidate PRS resources from which the plurality of reference PRS resources were selected by the UE.

14. The method of claim 12, wherein the batch report comprises a first message of a first message type and at least one additional message of a second message type.

15. The method of claim 14, wherein a reference PRS resource having a highest priority from the plurality of reference PRS resources is included in the first message.

16. The method of claim 14, wherein each message of the first message type and the second message type (i) corresponds with a different respective reference PRS resource of the plurality of reference PRS resources, and (ii) includes measurements using the respective reference PRS resource.

17. The method of claim 12, wherein the batch report comprises a single message.

18. The method of claim 17, wherein, for each measurement included in the batch report, the measurement is associated with an identifier of a corresponding reference PRS resource used for the measurement.

19. The method of claim 12, further comprising, prior to receiving the batch report, indicating different reference PRS resources of the plurality of reference PRS resources to use for different PRS instances of the plurality of PRS instances.

20. The method of claim 19, further comprising determining the different reference PRS resources of the plurality of reference PRS resources to use for the different PRS instances of the plurality of PRS instances based at least in part on determined movement of the UE.

21. A user equipment (UE) for selecting a reference signal for positioning of the UE, the UE comprising:
a transceiver;
a memory; and
one or more processors communicatively coupled with the transceiver and the memory, wherein the one or more processors are configured to:
receive, via the transceiver, a positioning reference signal (PRS) configuration for a positioning session of the UE, wherein the PRS configuration indicates a duration of time during which, for each instance of a plurality of PRS instances, the UE is to perform at least one respective measurement using at least one reference PRS resource;
receive, via the transceiver, an indication that the UE is to provide a batch report indicative of the at least one respective measurement for each instance of the plurality of PRS instances; and
perform the at least one respective measurement for each instance of the plurality of PRS instances, wherein performing the at least one respective measurement for each instance of the plurality of PRS instances comprises selecting, from a plurality of candidate PRS resources, the at least one reference PRS resource based at least in part on:
a measured characteristic of the at least one reference PRS resource, or
a received indication of the at least one reference PRS resource, or
a combination thereof.

22. The UE of claim 21, wherein the one or more processors are further configured to provide the batch report to a location server, wherein the batch report includes an indication of the at least one reference PRS resource.

23. The UE of claim 22, wherein the at least one reference PRS resource comprises a single reference PRS resource, and wherein the batch report comprises a single message.

24. The UE of claim 22, wherein the at least one reference PRS resource comprises a plurality of reference PRS resources, and wherein the batch report comprises a first message of a first message type and at least one additional message of a second message type.

25. The UE of claim 21, wherein the measured characteristic of the at least one reference PRS resource comprises:
a signal-to-noise ratio (SNR) value of an earliest arrival path of the at least one reference PRS resource,
a minimum time of arrival (ToA) value of the at least one reference PRS resource, or
a SNR value of a maximum peak of the at least one reference PRS resource, or
a combination thereof.

26. A location server for supporting batch reporting of reference signals for positioning of a user equipment (UE), the location server comprising:
a transceiver;
a memory; and
one or more processors communicatively coupled with the transceiver and the memory, wherein the one or more processors are configured to:
send, via the transceiver to the UE, a positioning reference signal (PRS) configuration for a positioning session of the UE, wherein the PRS configuration indicates a duration of time spanning a plurality of PRS instances during which the UE is to perform a plurality of measurements;
send, via the transceiver to the UE, an indication that the UE is to provide a batch report indicative of the plurality of measurements;
receive the batch report via the transceiver, wherein the batch report indicates a plurality of reference PRS resources used by the UE to perform the plurality of measurements; and
responsive to receiving the batch report, determine a location of the UE based at least in part on the plurality of measurements.

27. The location server of claim 26, wherein the one or more processors are further configured to include, in the PRS configuration, a plurality of candidate PRS resources from which the plurality of reference PRS resources were selected by the UE.

28. The location server of claim 26, wherein the batch report comprises a first message of a first message type and at least one additional message of a second message type.

29. The location server of claim 26, wherein the one or more processors are configured to receive the batch report in a single message.

30. The location server of claim 26, wherein the one or more processors are further configured to, prior to receiving the batch report, indicate different reference PRS resources of the plurality of reference PRS resources to use for different PRS instances of the plurality of PRS instances.
